(19) United States
(12) Patent Application Publication
(10) Pub. No.: US 2003/0228481 A1
(43) Pub. Date: Dec. 11, 2003

(54) Laminated resin plate

(75) Inventor: Tomohiro Maekawa, Niihama-shi (JP)

Correspondence Address: SUGHRUE MION, PLLC, 2100 PENNSYLVANIA AVENUE, N.W., WASHINGTON, DC, 20037, US

(73) Assignee: SUMITOMO CHEMICAL COMPANY, LIMITED

(21) Appl. No.: 10/452,725

(22) Filed: Jun. 3, 2003

(30) Foreign Application Priority Data
Jun. 6, 2002 (JP) 2002-165992

(51) Int. Cl. B32B 27/30

(52) U.S. Cl. 428/522

(57) ABSTRACT

A laminated resin plate is provided, the plate comprising a first layer of resin (A) comprising about 30-90% by weight of a methyl methacrylate unit and about 10-70% by weight of a styrene-type monomer unit; and a second layer, placed on at least one side of surfaces of the first layer, of resin (B) comprising about 50% by weight or more of a methyl methacrylate unit, wherein the second layer contains about 0.03-3 parts by weight of an ultraviolet absorber based on 100 parts by weight of resin (B). The laminated resin plate resists being deformed by water absorption and has an excellent light resistance. The laminated resin plate can be suitably used as a light-diffusing plate and the like.

### FIELD OF THE INVENTION

The present invention relates to a laminated resin plate that resists being deformed by water absorption and has an excellent light resistance.

### BACKGROUND OF THE INVENTION

Methyl methacrylate resin plates are used in various fields because of their excellent transparency. However, the plates have a relatively high water absorption capacity and, therefore, can have a problem of deformation such as warp and waviness. Against such a problem, a methyl methacrylate-styrene resin plate has been proposed in which the styrene monomer unit constituent can reduce the water absorption capacity. However, such a resin plate is insufficient in light resistance and can have a problem of degradation such as coloration depending on the conditions of use. One of the known methods for improving light resistance of resins is addition of an ultraviolet absorber (for example, JETI, Vol. 46, No. 5, 1998, 116-121). However, such a method has insufficient effect on some resins with low light resistance in some cases.

One of objects of the present invention is to provide a methyl methacrylate resin plate that resists being deformed by water absorption and has an excellent light resistance.

### SUMMARY OF THE INVENTION

As a result of active investigations, the inventor of the present invention has found that the above object and other objects can be achieved by laminating two resin layers with each other: one comprising a methyl methacrylate unit and a styrene-type monomer unit; and the other comprising a methyl methacrylate unit and containing an ultraviolet absorber. Base on the finding, the inventor has accomplished the present invention.

The present invention provides a laminated resin plate comprising:

a first layer that comprises resin (A) comprising about 30% by weight to about 90% by weight of a methyl methacrylate unit and about 10% by weight to about 70% by weight of a styrene-type monomer unit; and

a second layer that is placed on at least one side of surfaces of the first layer and comprises resin (B) comprising about 50% by weight or more of a methyl methacrylate unit, wherein the second layer contains about 0.03 part by weight to about 3 parts by weight of an ultraviolet absorber based on 100 parts by weight of resin (B).

### DETAILED DESCRIPTION OF THE INVENTION

A laminated resin plate of the present invention comprises a first layer comprising resin (A) and a second layer comprising resin (B) placed on at least one side of surfaces of the first layer.

Resin (A) comprises about 30% by weight to about 90% by weight of methyl methacrylate and about 10% by weight to about 70% by weight of a styrene-type monomer as the monomer units thereof. The styrene-type monomer may be a styrene or any substituted styrene. Examples of the substituted styrene include halogenated styrenes such as chlorostyrene and bromostyrene; vinyl toluene; and alkyl styrenes such as α-methyl styrene. Two or more kinds of styrene-type monomers may be used in combination, if necessary.

Resin (A) comprises preferably about 50% by weight to about 85% by weight, more preferably about 60% by weight to about 80% by weight of the methyl methacrylate monomer unit; and comprises preferably about 15% by weight to about 50% by weight, more preferably about 20% by weight to about 40% by weight of the styrene-type monomer unit. If necessary, resin (A) may contain any monomer other than the methyl methacrylate and the styrene-type monomer as the monomer units thereof. In such a case, the content of such another monomer may be about 10% by weight or less based on resin (A).

Examples of such another monomer unit containable in resin (A) include other methacrylate esters such as ethyl methacrylate, butyl methacrylate, cyclohexyl methacrylate, phenyl methacrylate, benzylmethacrylate, 2-ethylhexylmethacrylate, and 2-hydroxyethyl methacrylate; acrylate esters such as methyl acrylate, ethyl acrylate, butyl acrylate, cyclohexyl acrylate, phenyl acrylate, benzyl acrylate, 2-ethylhexyl acrylate, and 2-hydroxyethylacrylate; unsaturated acids such as methacrylic acid and acrylic acid; acrylonitrile; methacrylonitrile; maleic anhydride; phenylmaleimide; and cyclohexylmaleimide. Two or more thereof may be contained in combination, if necessary. Resin (A) may also comprise a glutaric anhydride unit and/or a glutarimide unit.

Resin (B) comprises about 50% by weight or more of a methyl methacrylate monomer unit. Resin (B) may be a substantially homopolymer of methyl methacrylate or may be a copolymer comprising about 50% by weight or more of a methyl methacrylate and about 50% by weight or less of any monomer(s) copolymerizable with the methyl methacrylate. The content of the methyl methacrylate monomer unit in monomer units of resin (B) is preferably about 80% by weight to 100% by weight. Examples of the monomer unit containable in resin (B) other than the methyl methacrylate include the same styrene-type monomer and the same other monomers as described above as those in resin (A).

A layer comprising resin (B) may contain an ultraviolet absorber so as to provide a resulting laminated resin plate with a sufficient light resistance. The content of the ultraviolet absorber in the layer may be about 0.03 part by weight to about 3 parts by weight, is preferably about 0.1 parts by weight to about 2 parts by weight, and is more preferably about 0.3 parts by weight to about 1.5 parts by weight, based on 100 parts by weight of resin (B). When the ultraviolet absorber content is too low, the light resistance of the resulting laminated resin plate may be insufficient. When the content is too high, the ultraviolet absorber can tend to bleed at the surface of the laminated resin plate so that the appearance of the laminated resin plate can be degraded. If necessary, the layer comprising resin (A) may also contain the ultraviolet absorber. In such a case, the content of the ultraviolet absorber in resin (A) is preferably less than that in resin (B) in terms of cost, durability per unit of an ultraviolet absorber and the like. The content of the ultraviolet absorber in resin (A) by weight may be in the range of from about 0.01 times to about 0.1 times as much as that in resin (B).

As shown in the composition of the respective monomers described above, resin (A) and resin (B) may be the same when both resins respectively comprise about 50% by weight to about 90% by weight of a methyl methacrylate monomer unit and about 10% by weight to about 50% by weight of a styrene monomer unit. In such a case, a laminated resin plate comprising the layers, each layer of which comprises the same resin, is provided. As described above, however, the prescribed amount of ultraviolet absorber is contained in at least one layer of the laminated resin plate and, therefore, the resulting laminated resin plate can have a superior light resistance to that of a single layer plate with the same amount of the ultraviolet absorber. Also, compared to the single layer plate with the light resistance due to an ultraviolet absorber, the laminated resin plate in the present invention has the same light resistance as that of the single layer plate and suppresses the decrease in other physical properties such as transparency and heat resistance.

An ultraviolet absorber used in the present invention preferably has a maximum absorption at a wavelength in the range of from about 250 nm to about 320 nm. In particular, it is preferred to use an ultraviolet absorber having the maximum absorption at the wavelength ranging from about 250 nm to about 320 nm as the largest maximum absorption at a wavelength (which may hereinafter be indicated by λmax) ranging from about 250 nm to 800 nm, since such an ultraviolet absorber can provide the resulting laminated plate with improved light resistance and can also control coloration, which would otherwise be caused by visible-light absorption of the ultraviolet absorber. Additionally, at the largest maximum absorption wavelength, the ultraviolet absorber preferably has a molar absorption coefficient (which may hereinafter be indicated by εmax) of about 10000 mol⁻¹cm⁻¹ or more, more preferably about 15000 mol⁻¹cm⁻¹ or more, and preferably has a molecular weight (which may hereinafter be indicated by Mw) of about 400 or less, in terms of reduction in weight of the ultraviolet absorber to be used.

Examples of the ultraviolet absorber include a benzophenone-type, a cyanoacrylate-type, a salicylate-type, a nickel complex salt-type, a benzoate-type, a benzotriazole-type, amalonic ester-type, an oxalanilide-type and a cinnamic ester-type absorbers. If necessary, two or more kinds thereof may be used in combination. Preferred examples include the benzophenone-type, the benzotriazole-type, the malonic ester-type, the oxalanilide-type and the cinnamic ester-type absorbers. The malonic ester-type and oxalanilide-type ultraviolet absorbers are particularly preferred, since these ultraviolet absorbers can improve light resistance of the resulting laminated resin plate and can have less visible-light absorption so that the laminated plate can prevent from being colored.

Examples of the benzophenone-type ultraviolet absorber include 2,4-dihydroxybenzophenone (Mw: 214, λmax: 288 nm, εmax: 14100 mol⁻¹cm⁻), 2-hydroxy-4-methoxybenzophenone (Mw: 228, λmax: 289 nm, εmax: 14700 mol⁻cm⁻¹), 2-hydroxy-4-methoxybenzophenone-5-sulfonic acid (Mw: 308, λmax: 292 nm, εmax: 12500 mol⁻¹cm⁻¹), 2-hydroxy-4-octyloxybenzophenone (Mw: 326, λmax: 291 nm, εmax: 15300mol⁻¹cm⁻¹), 4-dodecyloxy-2-hydroxybenzophenone (Mw: 383, λmax: 290 nm, εmax: 16200 mol⁻¹cm⁻¹), 4-benzyloxy-2-hydroxybenzophenone (Mw: 304, λmax: 289nm, εmax: 15900 mol⁻¹cm⁻¹), 2,2′-dihydroxy-4,4′-dimethoxybenzophenone (Mw: 274, λmax: 289 nm, εmax: 11800 mol⁻¹cm⁻¹), 1,6-bis(4-benzoyl-3-hydroxyphenoxy)-hexane (Mw: 511, λmax: 290 nm, εmax: 30100 mol⁻¹cm⁻¹), and 1,4-bis(4-benzoyl-3-hydroxyphenoxy)-butane (Mw: 483, λmax: 290 nm, εmax: 28500 mol⁻¹cm⁻¹).

Examples of the cyanoacrylate-type ultraviolet absorber include ethyl 2-cyano-3,3-diphenyl acrylate (Mw: 277, λmax: 305 nm, εmax: 15600 mol⁻¹cm⁻¹) and 2-ethylhexyl 2-cyano-3,3-diphenyl acrylate (Mw: 362, λmax: 307 nm, εmax: 14400 mol⁻¹cm⁻¹).

Examples of the salicylate-type ultraviolet absorber include phenyl salicylate (Mw: 214, λmax: 312 nm, εmax: 5000 mol⁻¹cm⁻¹) and 4-tert-butylphenyl salicylate (Mw: 270, λmax: 312 nm, εmax: 5400 mol⁻cm⁻¹).

Examples of the nickel complex salt-type ultraviolet absorber include (2,2′-thiobis(4-tert-octylphenolate))-2-ethylhexylaminenic kel (II) (Mw: 629, λmax: 298 nm, εmax: 6600 mol⁻¹cm⁻¹).

Examples of the benzoate-type ultraviolet absorber include 2′,4′-di-tert-butylphenyl 3,5-di-tert-butyl-4-hydroxybenzoate (Mw: 436, λmax: 267 nm, εmax: 20200 mol⁻¹cm⁻¹).

Examples of the benzotriazole-type ultraviolet absorber include 2-(2-hydroxy-5-methylphenyl)-2H-benzotriazole (Mw: 225, λmax: 300 nm, εmax: 13800 mol⁻¹cm⁻¹), 5-chloro-2-(3,5-di-tert-butyl-2-hydroxyphenyl)-2H-benzotri azole (Mw: 358, λmax: 312 nm, εmax: 14600 mol⁻¹cm⁻), 2-(3-tert-butyl-2-hydroxy-5-methylphenyl)-5-chloro-2H-benz otriazole (Mw: 316, λmax: 354 nm, εmax: 14300 mol⁻¹cm⁻¹), 2-(3,5-di-tert-pentyl-2-hydroxyphenyl)-2H-benzotriazole (Mw: 352, λmax: 305 nm, εmax: 15200 mol⁻¹cm⁻¹), 2-(3,5-di-tert-butyl-2-hydroxyphenyl)-2H-benzotriazole (Mw: 323, λmax: 303 nm, εmax: 15600 mol⁻¹cm⁻¹), 2-(2H-benzotriazole-2-yl)-4-methyl-6-(3,4,5,6-tetrahydroph thalimidylmethyl)phenol (Mw: 388, λmax: 304 nm, εmax: 14100 mol⁻¹cm⁻¹) , and 2-(2-hydroxy-5-tert-octylphenyl)-2H-benzotriazole (Mw: 323, λmax: 301 nm, εmax: 14700 mol⁻¹cm⁻¹).

Examples of the malonic ester-type ultraviolet absorber include 2-(1-arylalkylidene)malonic esters. Among them, it is preferred to use the compound represented by the following

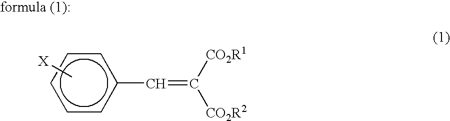

wherein X represents a hydrogen atom, an alkyl group with 1 to 6 carbon atoms, or an alkoxy group with 1 to 6 carbon atoms, and R¹ and R² each independently represent an alkyl group with 1 to 6 carbon atoms.

In formula (1), the alkyl group represented by X and the alkyl group in the alkoxy group represented by X may each have a liner-chain structure or a branched-chain structure, for example, including a methyl group, an ethyl group, a n-propyl group, an isopropyl group, a n-butyl group, an isobutyl group, a sec-butyl group, and a tert-butyl group. X is preferably a hydrogen atom, an alkyl group with 1 to 4 carbon atoms, or an alkoxy group with 1 to 4 carbon atoms. The substituent X is preferably in a para position.

In formula (1), the alkyl group represented by R¹ or R² may have a liner-chain structure or a branched-chain structure, for example, including a methyl group, an ethyl group, a n-propyl group, an isopropyl group, a n-butyl group, an isobutyl group, a sec-butyl group, and a tert-butyl group. R¹ and R² are each preferably an alkyl group with 1 to 4 carbon atoms.

Particularly preferred examples of the compound represented by formula (1) include dimethyl 2-(paramethoxybenzylidene)malonate (Mw: 250, λmax: 308 nm, εmax: 24200 mol⁻¹cm⁻¹).

Examples of the oxalanilide type ultraviolet absorber include alkoxyoxalanilides, particularly preferably including the compound represented by the following formula (2):

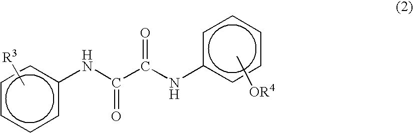

wherein R³ and R⁴ each independently represent an alkyl group with 1 to 6 carbon atoms.

In formula (2), the alkyl group represented by R³ or R⁴ may have a liner-chain structure or a branched-chain structure, for example, including a methyl group, an ethyl group, a n-propyl group, an isopropyl group, a n-butyl group, an isobutyl group, a sec-butyl group, and a tert-butyl group. R³ and R⁴ are each preferably an alkyl group with 1 to 4 carbon atoms. The substituents R³and R⁴O are each preferably in an ortho position.

Preferred examples of the compound represented by formula (2) include 2-ethoxy-2′-ethyloxalanilide (Mw: 312, λmax: 298 nm, εmax: 16700 mol⁻¹cm⁻¹).

Examples of the cinnamic ester type ultraviolet absorber include a 2-(1-arylalkylidene) cinnamic ester, particularly preferably including the compound represented by the following formula (2)′:

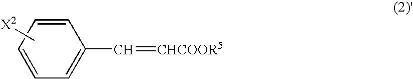

wherein X² represents hydrogen atom, an alkyl group or an alkoxy group, and R⁵ represents an alkyl group.

In formula (2)′, the alkoxy group represented by X² may have a liner-chain structure or a branched-chain structure, for example, including an alkoxy group with 1 to 6 carbon atoms such as a methoxy group, an ethoxy group, a n-propoxy group, an isopropoxyl group, a n-buthoxy group, an isobuthoxy group, a sec-buthoxy group, a tert-buthoxy group and n-penthoxy group. Among them, alkoxy groups with 1 to 4 carbon atoms are preferred as X².

In formula (2)′, the alkyl group represented by X² may have a liner-chain structure or a branched-chain structure, for example, including an alkyl group with 1 to 6 carbon atoms such as a methyl group, an ethyl group, a n-propyl group, an isopropyl group, a n-butyl group, an isobutyl group, a sec-butyl group, a tert-butyl group, a n-pentyl group and a n-hexyl group. Among them, alkyl groups with 1 to 4 carbon atoms are preferred as X².

X² is more preferably an alkoxy group, and is most preferably a methoxy group.

In formula (2)′, the alkyl group represented by R⁵ includes an alkyl group with 1 to 10 carbon atoms such as a methyl group, an ethyl group, a n-propyl group, an isopropyl group, a n-butyl group, an isobutyl group, a sec-butyl group, a tert-butyl group, a n-pentyl group, a n-hexyl group, a n-heptyl group, a n-octyl group, a n-nonyl group, a n-decanyl group, a 1-methylpentyl group, a 1-ethylpentyl group, a 1-methylhexyl group and a 2-ethylhexyl group. Preferably, R⁵ is a methyl group or a 2-ethylhexyl group.

Particularly preferred examples of the compound represented by formula (2)′ include2-(paramethoxybenzylidene) cinnamic 2- ethylhexyl ester (Mw: 290, λmax: 304 nm, εmax: 23600 mol⁻¹cm⁻¹).

In order to have further improved light resistance, a laminated resin plate in the present invention preferably contains at least one of hindered amines, particularly including the compound having a 2,2,6,6-tetraalkylpiperidine structure. In this case, the hindered amine(s) may be added to one or both of the layers comprising resins (A) and (B), respectively. The content of the hindered amine(s) by weight may be about 2 times or less, and is preferably in the range of from about 0.01 to about 1 time, as much as that of the ultraviolet absorber in the laminated resin plate.

Examples of the hindered amines include a dimethyl succinate/1-(2-hydroxyethyl)-4-hydroxy-2,2,6,6-tetramethyl piperidine condensate; poly((6-(1,1,3,3-tetramethylbutyl)imino-1,3,5-triazine-2,4-diyl) ((2,2,6,6-tetramethyl-4-piperidyl)imino)hexamethylene ((2,2,6,6-tetramethyl-4-piperidyl)imino)); bis(1,2,2,6,6-pentamethyl-4-piperidyl) 2-(2,3-di-tert-butyl-4-hydroxybenzyl)-2-n-butylmalonate; bis(1,2,2,6,6-pentamethyl-4-piperidyl) 2-(3,5-di-tert-butyl-4-hydroxybenzyl)-2-n-butylmalonate; an N,N′-bis(3-aminopropyl)ethylenediamine/2,4-bis(N-butyl-N-(1,2,2,6,6-pentamethyl-4-piperidyl)amino)-6-chloro-1,3,5-triazine condensate; bis(2,2,6,6-tetramethyl-4-piperidyl)sebacate; bis(2,2,6,6-tetramethyl-4-piperidyl)succinate; and the compound represented by the following formula (3):

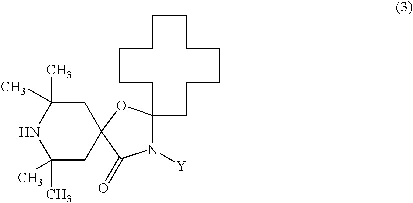

wherein Y represents a hydrogen atom, an alkyl group with 1 to 20 carbon atoms, a carboxyalkyl group with 2 to 20 total carbon atoms, an alkoxyalkyl group with 2 to 25 total carbon atoms, or an alkoxycarbonylalkyl group with 3 to 25 total carbon atoms. If necessary, two or more thereof may be used in combination.

In formula (3), each alkyl group in Y including the alkyl group represented by Y, the alkyl group in the carboxyalkyl group, the two alkyl groups in the alkoxyalkyl group (i.e., the alkyl group in the alkoxy group and the substituent alkyl group on the alkoxy group), and the two alkyl groups in the alkoxycarbonylalkyl group (i.e., the alkyl group in the alkoxy group and the substituent alkyl group on the alkoxycarbonyl group) may have a liner-chain structure or a branched-chain structure. Y is preferably a hydrogen atom or an alkoxycarbonylalkyl group with 5 to 24 total carbon atoms, and is more preferably a hydrogen atom or an alkoxycarbonylethyl group. Examples of the alkoxycarbonylethyl group include a dodecyloxycarbonylethyl group, a tetradecyloxycarbonylethyl group, a hexadecyloxycarbonylethyl group, and an octadecyloxycarbonylethyl group.

The laminated resin plate in the present invention may include a light-diffusing agent so as to be suitably used as a light-diffusing plate. Typical examples of the light-diffusing plate, which constitutes a lighting device together with a light source such as a cold cathode fluorescent lamp and an LED, include a light-diffusing member such as an illuminated signboard, a lighting cover, and a light-diffusing plate for display. In these usages, the temperature varies with on and off switching of the light source, and in such an environment, the water absorption of the light-diffusing plate can easily change. Many of the conventional light-diffusing plates have therefore problems of deformation such as warp and waviness and associated odd sounds such as cracking and snapping sounds. In contrast, the light-diffusing plate formed of the laminated resin plate in the present invention can be free from such problems. Particularly, in the usage for liquid crystal displays, conventional light-diffusing plates can deform to have an adverse effect on other members such as liquid crystal cells. Such a problem can effectively be eliminated by using the laminated resin plate in the present invention as the light-diffusing plate.

The light-diffusing agent may be added to one or both of the layers comprising resins (A) and (B), respectively, and is preferably added at least to the layer comprising resin (A). To each of the layers comprising resins (A) and (B), respectively, the light-diffusing agent may be added in an amount of from about 0.1 part by weight to about 10 parts by weight, is preferably in an amount of from about 0.3 part by weight to 7 parts by weight, and is more preferably in an amount of from about 1 part by weight to about 5 parts by weight, based on 100 parts by weight of the base resin in each layer. A too low content of the light-diffusing agent can provide the laminated plate with an insufficient light-diffusing property, and a too high content tends to reduce the strength of the laminated plate. The light-diffusing agent preferably has a weight average particle diameter of about 1 μm or larger in terms of hiding property and of about 20 μm or smaller in terms of strength.

The light-diffusing agent may be inorganic or organic transparent particulates of which refractive index differs from that of the base resin (A) or (B). The absolute value of the difference in refractive index between the light-diffusing agent and the base resin is preferably about 0.02 or more in terms of light-diffusing performance, and is preferably about 0.13 or less in terms of light transmission. Such difference in refractive index between the light-diffusing agent and the base resin can produce so called internal diffusion property.

Examples of the inorganic light-diffusing agent include agents comprising calcium carbonate, barium sulfate, titanium oxide, aluminum hydroxide, silica, glass, talc, mica, white carbon, magnesium oxide and zinc oxide, respectively. The agents may be subjected to surface treatment with fatty acid or the like. Examples of the organic light-diffusing agent include a styrene-type polymer particle, an acrylic polymer particle, and a siloxane type polymer particle. Preferred examples include a high molecular-weight polymer particle with a weight average molecular weight of 500,000 to 5,000,000 and a crosslinked polymer particle that has a gel fraction of 10% or more when dissolved in acetone. Two types or more of the light-diffusing agents may be used in combination, if necessary.

The styrene-type polymer particle preferably is made from about 50% by weight or more of a styrene-type monomer having one radical-polymerizable double bond per molecule. (Hereinafter, the monomer having one radical-polymerizable double bond per molecule may be referred to as a monofunctional monomer, and the monomer having at least two radical-polymerizable double bonds per molecule may be referred to as a polyfunctional monomer). Examples of the styrene-type polymer particle include a high-molecular-weight polymer particle formed by the polymerization of a styrene-type monofunctional monomer; a high-molecular-weight polymer particle formed by the polymerization of a styrene-type monofunctional monomer and any other monofunctional monomer; a crosslinked polymer particle formed by the polymerization of a styrene-type monofunctional monomer and any polyfunctional monomer; and a crosslinked polymer particle formed by the polymerization of a styrene-type monofunctional monomer, any other monofunctional monomer and any polyfunctional monomer. These styrene-type polymer particles can be produced by suspension polymerization, micro suspension polymerization, emulsion polymerization, dispersion polymerization, or the like.

Examples of the styrene-type monofunctional monomer for forming the styrene-type polymer particle include styrene; halogenated styrene such as chlorostyrene and bromostyrene; vinyl toluene; and alkyl styrene such as α-methyl styrene. Two or more of the styrene-type monofunctional monomers may be used in combination, if necessary.

Examples of the monofunctional monomer other than the styrene-type monofunctional monomer for forming the styrene-type polymer particle include methacrylate esters such as methyl methacrylate, ethyl methacrylate, butyl methacrylate, cyclohexyl methacrylate, phenyl methacrylate, benzyl methacrylate, 2-ethylhexyl methacrylate, and 2-hydroxyethyl methacrylate; acrylate esters such as methyl acrylate, ethyl acrylate, butyl acrylate, cyclohexyl acrylate, phenyl acrylate, benzyl acrylate, 2-ethylhexyl acrylate, and 2-hydroxyethyl acrylate; and acrylonitrile. Two or more of the monofunctional monomers other than the styrene-type monofunctional monomer may be used in combination, if necessary. Preferred examples include the methacrylate esters such as methyl methacrylate.

Examples of the polyfunctional monomer for forming the styrene-type polymer particle include di- or more- methacrylates of polyhydric alcohols such as 1,4-butanediol dimethacrylate, neopentyl glycol dimethacrylate, ethylene glycol dimethacrylate, diethylene glycol dimethacrylate, tetraethylene glycol dimethacrylate, propylene glycol dimethacrylate, tetrapropylene glycol dimethacrylate, trimethylolpropane trimethacrylate, and pentaerythritol tetramethacrylate; di- or more- acrylates of polyhydric alcohols such as 1,4-butanediol diacrylate, neopentyl glycol diacrylate, ethylene glycol diacrylate, diethylene glycol diacrylate, tetraethylene glycol diacrylate, propylene glycol diacrylate, tetrapropylene glycol diacrylate, trimethylolpropane triacrylate, and pentaerythritol tetraacrylate; and aromatic polyfunctional monomers such as divinyl benzene and diallyl phthalate. Two or more of the polyfunctional monomers may be used in combination, if necessary.

The styrene-type polymer particle may have a refractive index of about 1.53 to about 1.61, although the refractive index is appropriately selected depending on the constituent of the particle. As the styrene-type polymer particle has more phenyl or halogeno groups, the refractive index of the particle generally tends to be higher.

The acrylic polymer particle preferably is mode from about 50% by weight or more of an acrylic monofunctional monomer unit. Examples of the acrylic polymer particle include a high-molecular-weight polymer particle formed by the polymerization of an acrylic monofunctional monomer; a high-molecular-weight polymer particle formed by the polymerization of an acrylic monofunctional monomer and any other monofunctional monomer; a crosslinked polymer particle formed by the polymerization of an acrylic monofunctional monomer and any polyfunctional monomer; and a crosslinked polymer particle formed by the polymerization of an acrylic monofunctional monomer, any other monofunctional monomer and any polyfunctional monomer. These acrylic polymer particles can be produced by suspension polymerization, micro suspension polymerization, emulsion polymerization, dispersion polymerization, or the like.

Examples of the acrylic monofunctional monomer for forming the acrylic polymer particle include methacrylate esters such as methyl methacrylate, ethyl methacrylate, butyl methacrylate, cyclohexyl methacrylate, phenyl methacrylate, benzyl methacrylate, 2-ethylhexyl methacrylate, and 2-hydroxyethyl methacrylate; acrylate esters such as methyl acrylate, ethyl acrylate, butyl acrylate, cyclohexyl acrylate, phenyl acrylate, benzyl acrylate, 2-ethylhexyl acrylate, and 2-hydroxyethyl acrylate; methacrylic acid; and acrylic acid. Two or more of the acrylic monofunctional monomers may be used in combination, if necessary.

Examples of the monofunctional monomer other than the acrylic monofunctional monomer for forming the acrylic polymer particle include the above examples of the styrene-type monofunctional monomer and acrylonitrile, and two or more thereof may be used in combination, if necessary. Styrene is particularly preferred. Examples of the polyfunctional monomer for forming the acrylic polymer particle include the above polyfunctional monomers for forming the styrene-type polymer particle, and two or more thereof may be used in combination, if necessary.

The acrylic polymer particle may have a refractive index of about 1.46 to about 1.55, although the refractive index is appropriately selected depending on the constituent of the particle. In a similar manner to the styrene-type polymer particle, as the acrylic polymer particle has more phenyl or halogeno groups, the refractive index of the particle generally tends to be higher.

The siloxane type polymer particle is preferably made from the material generally called silicone rubber or silicone resin, wherein the material is in a solid state at ordinary temperature. The siloxane-type polymer is preferably produced by hydrolysis and condensation of chlorosilane such as dimethyldichlorosilane, diphenyldichlorosilane, phenylmethyldichlorosilane, methyltrichlorosilane, and phenyltrichlorosilane. The resulting polymer may be allowed to react with a peroxide such as benzoyl peroxide, 2,4-dichlorobenzoyl peroxide, p-chlorobenzoyl peroxide, dicumyl peroxide, di-tert-butyl peroxide, 2,5-dimethyl-2,5-di(tert-butylperoxy)hexane to form a crosslinked polymer. If the polymer has a silanol terminal end group, the polymer may be condensed and crosslinked with any alkoxysilane. Preferred examples of the polymer include a crosslinked polymer having two to three organic groups per one silicon atom.

The siloxane-type polymer particle may be prepared by mechanically pulverizing a siloxane type polymer. According to the description in Japanese Patent Laid-Open No. 59-68333, the siloxane-type polymer particle may be prepared as a spherical particle by curing an atomized curable polymer with a linear organosiloxane block or an atomized composition containing such a polymer. Alternatively, according to the description in Japanese Patent Laid-Open No. 60-13813, the siloxane-type polymer particle may be produced as a spherical particle by hydrolysis and condensation of alkyltrialkoxysilane or its partially hydrolyzed condensate in an aqueous solution of ammonia or an amine.

The siloxane-type polymer particle may have a refractive index of about 1.40 to about 1.47, although the refractive index is appropriately selected depending on the constituent of the particle. As the siloxane-type polymer particle has more phenyl groups or the organic groups directly connected to the silicon atom, the refractive index of the particle generally tends to be higher.

When a laminated resin plate in the present invention further contains a surfactant and is used as a light-diffusing plate, the above-described problem of the odd sound caused by the deformation of the light-diffusing plate can be more effectively solved. Any anionic, cationic, amphoteric, or nonionic surfactant may be added to the laminated resin plate, and particularly, the anionic surfactant such as sulfonic acid, a sulfate monoester and salts thereof is preferred. Such examples include sodium lauryl sulfate, sodium cetyl sulfate, and sodium stearyl sulfate.

The surfactant may be added to one or both of the layers comprising resins (A) and (B), respectively, and is preferably added at least to the layer comprising resin (B). To each of the layers comprising resins (A) and (B), respectively, the surfactant may be added in an amount of about 0.1 part by weight to about 5 parts by weight, is preferably about 0.2 part by weight to about 3 parts by weight, and is more preferably about 0.3 part by weight to about 1 part by weight, based on 100 parts by weight of the base resin in each layer.

When a laminated resin plate in the present invention is used as a light-diffusing plate, particularly as a lighting cover, at least one side of the surfaces of the laminated resin plate preferably has an irregular shape so as to have so called a matte surface. The irregular shape may have about 1 μm to about 50 μm of ten points average roughness (Rz) and may have about 10 μm to about 300 μm of average spacing of roughness peak (Sm). A too small Rz may provide insufficient matte effect, while a too large Rz may provide insufficient surface impact strength of the resulting laminated resin plate. A too large Sm may provide insufficient matte effect, while a too small Sm can provide insufficient surface impact strength of the resulting laminated resin plate.

The irregular shape can be provided for the surface of a laminated resin plate by the methods below. In the process for producing the laminated resin plate by extrusion molding, the irregular shape of the plate surface can be formed by adding insoluble resin particles to the base resin of the surface layer of the resin plate, or by transferring the irregular shape to the surface with a roller (roller-transfer). In the process for producing the laminated resin plate by cast molding, the irregular shape of the plate surface can be formed by transferring the irregular shape to the surface from a cell (cell-transfer).

When the insoluble resin particles are added to form the irregularly shaped surface, the particles may have a weight average particle diameter of about 1 μm to about 50 μm. The insoluble resin particles may be added to one or both of the layers comprising resins (A) and (B), respectively, and are preferably added at least to the layer comprising resin (B). To each of the layers comprising resins (A) and (B), respectively, the insoluble resin particles may be added in an amount of about 3 parts by weight to about 20 parts by weight, based on 100 parts by weight of the base resin in each layer. In terms of the surface impact strength of the resulting laminated resin plate, the monomer composition of the insoluble resin particles is preferably close to that of the base resin. For example, when the insoluble resin particles are added to resin (A), the insoluble resin particles are preferably made from across linked or high-molecular-weight resin comprising about 30% by weight to about 90% by weight of a methyl methacrylate unit and about 10% by weight to about 70% by weight of a styrene-type monomer unit. When the insoluble resin particles are added to resin (B), the insoluble resin particles are preferably made from a crosslinked or high-molecular-weight resin comprising about 50% by weight or more of a methyl methacrylate unit.

In the present invention, the thickness of the laminated resin plate is appropriately decided depending on the usage, and may be in the range of from about 0.8 mm to about 5 mm. The ratio of resin (A) layer thickness to resin (B) layer thickness may be as follows: When the layer comprising resin (B) is formed on one side of surfaces of the layer comprising resin (A), the ratio (i.e., [the thickness of the layer comprising resin (A)]/[the thickness of the layer comprising resin (B)]) may be in the range of from about 99/1 to about 1.1/1; when the layers comprising resin (B) are formed on both sides of surfaces of the layer comprising resin (A), the ratio (i.e., [the thickness of the layer comprising resin (B)/[the thickness of the layer comprising resin (A)]/[the thickness of the layer comprising resin (B)]] may be in the range of from about 1/198/1 to about 1/2.2/1. In terms of light resistance, the laminated resin plate preferably has the layers comprising resin (B) formed on both sides of surfaces of the layer comprising resin (A). In terms of light resistance and cost, the total thickness of the layer or layers comprising resin (B) is preferably half or less of the thickness of the layer comprising resin (A). The layer comprising resin (B) preferably contains an ultraviolet absorber in a content of about 0.2 g/m² to about 10 g/m².

If necessary, the laminated resin plate in the present invention may contain an additive other than an ultraviolet absorber. Examples of such an additive include a high-impact material such as an acrylic multi-layered polymer and a graft rubber-like polymer; an antistatic agent such as polyetheresteramide; an antioxidant such as hindered phenol; a flame retardant such as phosphate esters; a lubricant such as palmitic acid and stearyl alcohol; and a dye. Two or more of the additives may be used in combination, if necessary.

A laminated resin plate in the present invention may be produced by co-extrusion molding, lamination, heat bonding, solvent bonding, polymerization bonding, cast polymerization, or surface coating.

In the process of the co-extrusion molding, for example, resins (A) and (B) each containing the desired components may be each independently melted and be kneaded using a uniaxial or biaxial extruder, and then be laminated to each other to be integrated via feed block dies or multi-manifold dies, followed by being cooled and solidified using a roll unit to obtain a laminated resin plate.

In the process of the lamination, for example, one of resins (A) and (B) each containing the desired components may be formed into a plate, and then the other resin in a melted state may be applied to the plate, to obtain a laminated resin plate.

In the process of the heat bonding, for example, resins (A) and (B) each containing the desired components may be each independently formed into a plate, and both plates may be pressed to be integrated at a temperature higher than both softening points, to obtain a laminated resin plate.

In the process of the solvent bonding, resins (A) and (B) each containing the desired components may be each independently formed into a plate, and both plates may be bonded to each other with a solvent dissolving one or both of the resins, to obtain a laminated resin plate.

In the process of the polymerization bonding, for example, resins (A) and (B) each containing the desired components may be each independently formed into a plate, and both plates may be bonded to each other with a heat-polymerizing or photo-polymerizing adhesive, to obtain a laminated resin plate. In this process, the adhesive preferably comprises the monomer which can be used as a starting material for resin (A) or (B) (or a partial polymer of the monomer) and a thermal- or photo-polymerization initiator.

In the process of the cast polymerization, for example, one of resins (A) and (B) each containing the desired components may be formed into a plate, and the plate may be placed on the inner surface of a cast molding cell, and then a monomer as the starting material for the other resin (or a partial polymer of the monomer) containing the desired components may be injected into the cell and is polymerized, to obtain a laminated resin plate.

In the process of the surface coating, for example, one of the resins (A) and (B) each containing the desired components may be formed into a plate, and a monomer as the starting material for the other resin (or a partial polymer of the monomer) containing the desired components may be applied to the plate and is polymerized, to obtain a laminated resin plate.

The thus-obtained laminated resin plate in the present invention can be used in a variety of indoor and outdoor usage. As described above, the laminated resin plate is preferably utilized as a light-diffusing plate. For example, the laminated resin plate can be used as a light-diffusing plate for a signboard, an illuminated signboard, a lighting cover, a showcase, or a display. As described above, typical usage include an illuminated signboard, a lighting cover, and a light-diffusing plate for display, each constituting a lighting device with a light source such as a cold cathode fluorescent lamp and an LED. Typical examples of the light-diffusing plate for display include a light-diffusing plate for a direct back light or an edge lit configuration back light of a liquid crystal display.

As described above, the present invention provides a laminated resin plate, which resists being deformed by water absorption and has an excellent light resistance. The laminated resin plate, for example, can be suitably used as a light-diffusing plate and the like.

The invention being thus described, it will be apparent that the same may be varied in many ways. Such variations are to be regarded as within the spirit and scope of the invention, and all such modifications as would be apparent to one skilled in the art are intended to be within the scope of the following claims.

The entire disclosure of the Japanese Patent Application No. 2002-165992 filed on Jun. 6, 2002, indicating specification, claims and summary, is incorporated herein by reference in their entirety.

### EXAMPLES

The present invention is described in more detail by following Examples, which should not be construed as a limitation upon the scope of the present invention. The extrusion apparatus used in each Example has the following units:

Extruder (1): screw diameter of 40 mm, uniaxial, with vent (manufactured by Tanabe Plastic Machinery Corporation);

Extruder (2): screw diameter of 20 mm, uniaxial, with vent (manufactured by Tanabe Plastic Machinery Corporation);

Feed Block: two kinds, three-layer distribution (manufactured by Tanabe Plastic Machinery Corporation);

Dies: T-dies, lip width of 250 mm, lip gap of 6 mm; and

Roll: three polishing rolls, vertical type.

The laminated resin plates prepared in Example were evaluated by the following physical property tests.

(1) Light Transparency:

According to JIS K 7361, a total light transmittance (Tt) was measured using a haze-transmittance meter (trade name: HR-100, manufactured by Murakami Color Research Laboratory).

(2) Hiding property and Light-Diffusing Properties:

An automatic goniophotometer (trade name: GP-1R, manufactured by Murakami Color Research Laboratory) was used to measure intensities (I₀, I₅ and I₇₀) of transmitted lights at transmission angles of 0 degree, 5 degrees and 70 degrees, respectively, with respect to vertically incident light. I₅/I₀ and I₇₀/I₀ were calculated and used as a hiding property index and a light-diffusing property index, respectively.

(3) Water Absorption Property:

A test piece (5 cm×5 cm) was cut out of each laminated resin plate and was dried at 80° C. for 24 hours in an oven, and then the weight (W₀) of the dried test piece was measured. After the dried test piece was immersed in purified water at 50° C. for 10 days, the weight (W) of the test piece was measured. A water absorption rate [=(W-W₀)/W₀×100 (%)] was calculated as a water absorption property of the laminated resin plate.

(4) Water Absorption Warping Test:

A test piece (18 cm×18 cm) was cut out of each laminated resin plate. The test piece was sandwiched between steel plates larger than the piece, was heated at a temperature of 90° C. for 5 hours, and then was allowed to stand to cool over 24 hours. The test piece was taken out and was flat-laid on a container (30 cm×23 cm). Purified water was then poured into the container in such a manner that only one side of surfaces of the test piece was immersed in the water. After the test piece was allowed to stand at a room temperature for 24 hours, a warping-up level (mm) was measured at each of four corners of the test piece. An average of the measured levels was calculated as the warp level of the laminated resin plate.

(5) Light Resistance:

A test piece (6 cm×7 cm) was cut out of each laminated resin plate and was continuously irradiated with ultraviolet light at a temperature of 60° C. for 200 hours using ATLAS-UVCON (manufactured by Toyo Seiki Seisaku-sho, LTD.). Before and after the irradiation, L*, a* and b* values of the test piece were measured in terms of L*a*b* color space which is defined by Commission International de l'Eclairage, respectively, in accordance with JIS K 7103 with respect to transmitted light and reflected light using a spectral color-difference meter (trade mane: SZ-Σ80, manufactured by Nippon Denshoku Industries Co., Ltd.) and the difference (ΔE) in the values between before and after the irradiation was obtained. The relationship between ΔE, L*, a* and b* values is in the equation below:

ΔE=√((L*₁-L*₀)²+(a*₁-a*₀)²+(b*₁-b*₀)²

(L*₀ and L*₁ are L* values before and after the irradiation, a*₀ and a*₁ are a* values before and after the irradiation, and b*₀ and b*₁ are b* values before and after the irradiation, respectively.)

(6) Surface Roughness:

According to JIS B 0601, a surface roughness and contour measuring system (trade name: Surfcom 550A, manufactured by Tokyo Seimitsu Co., Ltd.) was used to determine a ten points average height of irregularities (Rz) and an average spacing of roughness peak (Sm).

In Examples and Comparative Examples, the following resins were used:

MS: a copolymer of methyl methacrylate and styrene in a ratio (methyl methacrylate/styrene) of 70/30 by weight with a refractive index of 1.52; and

MA: a copolymer of methyl methacrylate and methyl acrylate in a ratio (methyl methacrylate/methyl acrylate) of 96/4 by weight with a refractive index of 1.49.

In Examples and Comparative Examples, the following light-diffusing agents were used:

Light-diffusing agent (1): copolymer particles of styrene and divinyl benzene in a ratio (styrene/divinylbenzene) of 95/5 by weight with a refractive index of 1.59 and a weight-average particle diameter of 6 μm;

Light-diffusing agent (2): crosslinked siloxane type polymer particles (trade name: Torayfil DY33-719, manufactured by Dow Corning Toray Silicone Co., Ltd.) with a refractive index of 1.42 and a weight-average particle diameter of 2 μm; and

Light-diffusing agent (3): a calcium carbonate (trade name: CUBE30AS, manufactured by Maruo Calcium Co., Ltd.) with a refractive index of 1.61 and a weight-average particle diameter of 4 μm.

The weight-average particle diameter of each light-diffusing agent and the insoluble resin particle below was a D₅₀ value determined with a light diffraction scattering particle size meter (trade name: Microtrac particle size analyzer Model 9220 FRA, manufactured by Nikkiso Co., Ltd.).

### Examples 1 to 6 and Comparative Examples 1 and 2

Each type of resin (A) in a given amount as shown in Table 1, 0.02 part by weight of a dimethyl 2-(paramethoxybenzylidene)malonate (which is an ultraviolet absorber, and is represented by formula (1) above wherein X is a methoxy group placed in a para position, and R¹ and R² are each a methyl group; trade name: Sanduvor PR-25, manufactured by Clariant), 0.01 part by weight of bis(2,2,6,6-tetramethyl-4-piperidyl)sebacate (which is a hindered amine; trade mane: Adekastab LA-77, manufactured by Asahi Denka Co., Ltd.) and each type of the light-diffusing agent in a given amount as shown in Table 1 were mixed using a Henschel mixer, were melted and kneaded in extruder (1), and then were supplied into a feed block.

Each type of resin (B) in a given amount as shown in Table 1, the dimethyl 2-(paramethoxybenzylidene)malonate (trade name: Sanduvor PR-25) in a given amount as shown in Table 1, 0.01 part by weight of the bis(2,2,6,6-tetramethyl-4-piperidyl)sebacate (trade name: Adekastab LA-77), 0.5 part by weight of a mixture (which is a surfactant) of sodium cetyl sulfate and sodium stearyl sulfate and 8 parts by weight of copolymer particles (which are insoluble resin particles) of methyl methacrylate and ethylene glycol dimethacrylate in a ratio (methyl methacrylate/ethylene glycol dimethacrylate) of 95/5 by weight, with a refractive index of 1.49 and a weight-average particle diameter of 4 μm, were mixed using a Henschel mixer, were melted and kneaded in extruder (2), and then were supplied to the feed block.

In each Example and Comparative Example, co-extrusion molding was carried out at an extruded resin temperature of 250° C. in which resin (A) was supplied from extruder (1) to the feed block so as to form an interlayer, while resin (B) was supplied from extruder (2) into the feed block so as to form surface layers placed on both sides of surfaces of the interlayer. As a result, a three-layer laminated resin plate was produced with a width of 23 cm and a thickness of 2 mm (having an interlayer thickness of 1.9 mm and a surface layer thickness of 0.05 mm for each of two surface layers). The evaluation results of the laminated resin plate are shown in Table 2.

TABLE 1

| | | | | | | | Ultraviolet |
|---|---|---|---|---|---|---|---|
| | Resin (A) | | Light-Diffusing Agent | | Resin (B) | | absorber |
| | | Parts by | | Parts by | | Parts by | Parts by |
| | Type | weight | Type | weight | Type | weight | weight |
| Example 1 | MS | 100 | (1)/(2) | 0.8/0.8 | MS | 100 | 0.5 |
| Example 2 | MS | 100 | (1)/(2) | 0.8/0.8 | MS | 100 | 1 |
| Example 3 | MS | 100 | (1)/(2) | 0.8/0.8 | MA | 100 | 1 |
| Example 4 | MS | 100 | (1)/(2) | 0.8/0.8 | MA | 100 | 0.5 |
| Example 5 | MS | 100 | (3) | 3 | MA | 100 | 0.5 |
| Example 6 | MS/MA | 90/10 | (1)/(2) | 0.8/0.8 | MA | 100 | 0.5 |
| Comparative | MA | 100 | (1)/(2) | 0.8/0.8 | MA | 100 | 0.1 |
| Example 1 | | | | | | | |
| Comparative | MS | 100 | (1)/(2) | 0.8/0.8 | MA | 100 | 0 |
| Example 2 | | | | | | | |

TABLE 2

| | | | | Water | | | |
|---|---|---|---|---|---|---|---|
| | | | | Absorp- | | ΔE | |
| | | | | tion | Warp | Trans- | |
| | Tt | I₅/I₀ | I₇₀/I₀ | Rate | Level | mitted/ | Rz/sm |
| | (%) | (%) | (%) | (%) | (mm) | Reflected | (μ) |
| Example 1 | 59.5 | 99.1 | 24.3 | 1.1 | 1.98 | 2.4/5.9 | 3.0/30 |
| Example 2 | 59.7 | 99.2 | 24.5 | 1.1 | 2.02 | 2.1/4.5 | 3.2/33 |
| Example 3 | 59.7 | 99.2 | 24.5 | 1.1 | 2.07 | 1.1/1.9 | 3.1/35 |
| Example 4 | 60.4 | 99.2 | 23.9 | 1.1 | 2.11 | 0.9/2.3 | 2.8/38 |
| Example 5 | 67.0 | 98.9 | 9.6 | 1.1 | 1.98 | 0.9/1.4 | 3.3/36 |
| Example 6 | 60.1 | 98.7 | 23.5 | 1.1 | 2.05 | 1.2/2.8 | 3.2/32 |
| Comparative | 62.7 | 98.7 | 20.6 | 2.2 | 3.03 | 5.1/10.5 | 3.2/34 |
| Example 1 | | | | | | | |
| Comparative | 59.3 | 99.2 | 24.5 | 1.1 | 2.10 | 14.8/24.7 | 3.1/33 |
| Example 2 | | | | | | | |

What is claimed is:

1. A laminated resin plate comprising:
a first layer that comprises resin (A) comprising about 30% by weight to about 90% by weight of a methyl methacrylate unit and about 10% by weight to about 70% by weight of a styrene-type monomer unit; and
a second layer that is placed on at least one side of surfaces of the first layer and comprises resin (B) comprising about 50% by weight or more of a methyl methacrylate unit, wherein the second layer contains about 0.03 part by weight to about 3 parts by weight of an ultraviolet absorber based on 100 parts by weight of resin (B).

2. The laminated resin plate according to claim 1, wherein resin (B) comprises at least about 80% by weight of the methyl methacrylate unit.

3. The laminated resin plate according to claim 1 or 2, wherein the ultraviolet absorber has a maximum absorption at a wavelength in the range of from about 250 nm to about 320 nm.

4. The laminated resin plate according to claim 1 or 2, wherein the first layer comprising resin (A) contains about 0.1 part by weight to about 10 parts by weight of a light-diffusing agent based on 100 parts by weight of resin (A).

5. The laminated resin plate according to claim 1 or 2, wherein the laminated resin plate has at least one irregularly shaped surface.
